(19) United States
(12) Patent Application Publication
(10) Pub. No.: US 2026/0139076 A1
(43) Pub. Date: May 21, 2026

(54) SUSTAINABLE PROCESS FOR PREPARING CELLULOSE- BASED, BIODEGRADABLE RESINS AND PRODUCTS PREPARED THEREFROM

(71) Applicants: Thomas-Anthony R. Viscione, Richmond, RI (US); Nicholas J. Condon, Wakefield, RI (US); Francis L. Jacques, North Smithfield, RI (US)

(72) Inventors: Thomas-Anthony R. Viscione, Richmond, RI (US); Nicholas J. Condon, Wakefield, RI (US); Francis L. Jacques, North Smithfield, RI (US)

(21) Appl. No.: 19/396,607

(22) Filed: Nov. 21, 2025

Related U.S. Application Data
(60) Provisional application No. 63/723,449, filed on Nov. 21, 2024.

(51) Int. Cl. C08B 15/00

(52) U.S. Cl. CPC C08B 15/00

(57) ABSTRACT

A process for treating cellulose material and the products prepared therefrom are provided. Additional processing methods that modify the cellulose material for use in a range of applications are also provided. For example, the resultant cellulose-based resins can be molded or otherwise processed to form various household and industrial articles. The cellulose-based resins can further serve, for example, as adhesives, coatings, or binding agents for a wide variety of particulate, fibrous, and powder-like materials. The resultant materials may be used, for example, in the manufacture of biodegradable household, agricultural, industrial, environmental, and filtration products, including molded articles, soil amendments, biochar pellets, nutrient delivery systems, and remediation media.

### CROSS-REFERENCE TO RELATED APPLICATIONS

The application claims the benefit of U.S. Provisional Patent Application No. 63/723,449 filed Nov. 21, 2024, the entire disclosure of which is hereby incorporated by reference.

### BACKGROUND OF THE INVENTION

### Field of the Invention

The present invention relates generally to a sustainable and adaptable process for treating cellulose material to form biodegradable resins and products prepared therefrom. The resultant cellulose-based resins can be further molded, coated, or otherwise processed to form a wide variety of biodegradable household, agricultural, medical, industrial, and environmental articles.

### Brief Review of the Related Art

Cellulose is used in many different industries such as pharmaceutical, food, textiles, chemical, agriculture, filtration, and paper manufacturing. Many sectors are seeking environmentally responsible and economically viable ways to extract cellulose from natural materials or recycle cellulose waste.

Other industries such as the textile and apparel sectors have explored recycling post-consumer cellulose. Consumers generate a significant amount of cotton waste when disposing of clothing, towels, rugs, mats, and the like. Lin et al., U.S. Patent Application Publication 2020/0199257 discloses chemically recycling cellulose waste such as cotton. In one embodiment, the method includes hydrolyzing cotton waste and dissolving cellulose in an aqueous solution containing an alkali hydroxide such as sodium hydroxide, lithium hydroxide, or potassium hydroxide, and one or more of urea, polyethylene glycol, or thiourea to produce another aqueous solution containing dissolved cellulose. This second aqueous solution can be extruded into a regenerated fiber.

In recent years, manufacturers have developed different ways of treating cellulose to produce various end-use products. For example, Chen et al., U.S. Pat. No. 5,817,381 discloses a process for converting cellulose fiber, particularly non-wood cellulose fiber, into compositions used for self-supporting films and coatings, including edible or biodegradable packaging materials. The process generally involves reducing the fiber size, treating the fiber to reduce or remove lignin, adding a liquid into the fiber mass, combining the fiber and liquid under pressure, reducing the pressure rapidly to microfibrillate the fiber, and drying the resultant composition.

Kumar, U.S. Patent Application Publication 2020/0199257 discloses a cellulose excipient suitable for use as a binder or filler in the development of solid drug compacts/tablets and as a bodying agent or drug carrier in the preparation of topical formulations such as lotions and gels. The cellulose excipient is formed by soaking a source of cellulose in an aqueous alkali metal hydroxide (e.g. sodium or potassium hydroxide) solution. The cellulose is then regenerated, washed, and optionally hydrolyzed with a dilute mineral acid.

Matsusue, U.S. Pat. No. 11,441,243 discloses a method for producing fine cellulose fiber having high transparency and viscosity for the paper-making industry. The fine cellulose fiber has a width of 1 μm or less. The method involves adding Additive (A) which is phosphorous-oxo acid or a phosphorous-oxo acid metal salt and Additive (B) which is urea or a urea derivative. In the mixture, the phosphoric acid groups form an ester with a hydroxyl group of the cellulose. The mixture is heated to a temperature of about 100° to about 210° C. Then, the mixture is washed and mechanically processed.

Shimura et al., U.S. Pat. No. 11,4343,350 discloses a method for making a cellulose resin that can be used to make packaging, films, components for electronic devices, home appliances, automobiles, building materials, furniture, writing materials, and the like. A cellulose resin comprising: a) cellulose derivative; and b) lubricant is first prepared. Urea compounds can be used as the lubricant. The cellulose derivative is prepared by introducing a long-chain organic group of a fatty acid into the cellulose material. Alkaline metal hydroxide solvents such as sodium hydroxide and potassium hydroxide can be used.

However, there are some drawbacks with such conventional methods for treating cellulose fiber. For example, many conventional methods for treating cellulose fiber to make hydrocarbon products are time-consuming, and often rely on hazardous chemicals, complex processing, and equipment-intensive techniques that are ecologically and economically burdensome. There remains a need for a process that simplifies cellulose treatment using cost-effective, environmentally friendly, and scalable methods that yield functional, biodegradable resins. The present invention addresses these needs and provides a versatile platform for cellulose valorization across multiple industries.

The resulting cellulose-based resins of the present invention may be used in a wide variety of applications including, but not limited to, adhesives, coatings, or binders for fine powders and particulate matter, including, but not limited to, biochar, compost, activated carbon, industrial waste, seaweed, kelp, and the like.

In recent years, there has been growing interest in using biochar material for remediating soil and improving plant growth. Biochar is a highly porous and stable material that is rich in carbon. In general, the cycle for producing biochar begins with trees absorbing carbon dioxide during photosynthesis. Biomass material used to make biochar can include various materials such as, for example, wood, forestry residue, agricultural products, construction debris, organic waste, seaweed, kelp, and other organic materials containing carbon dioxide. The biomass material is burned in a pyrolysis chamber, which is an oxygen-deficient environment. This pyrolysis process produces biochar, a charcoal-like material containing carbon. If the biomass material had not gone through this process, the carbon from the carbon dioxide would stay stored in the living plant and then it would have been typically released into the atmosphere as the plant decomposed. The biochar produced from this pyrolysis process can store the carbon from the carbon dioxide. Then, the biochar can be added to agricultural soil and stored therein. That is, the carbon is removed from the carbon cycle and helps remediate the soil and improve crop yields.

As discussed above, biochar can be added to agricultural soil to improve crop yields. The biochar can be added to the soil with other agricultural products such as plant seed and fertilizer. The biochar helps remove toxins from the soil, hold nutrients, and stabilizes the soil. However, one problem is that since the charcoal in the biochar is somewhat brittle and fragile, it can be easily crumbled. When traditional biochar is applied to agricultural fields with conventional equipment, it is difficult to handle and can create dust and other undesirable conditions. To overcome this problem, methods have been developed to pelletize the biochar.

For example, Eddy et al., U.S. Pat. No. 8,986,581 discloses method for producing biochar particles or pellets which use sulfur and other additives. The method includes producing a mixture of biochar and additives selected from sulfur, lignin, and gluten. The mixture is mixed with water and passed through an extruder to produce an extrudate. The extrudate is then cut into pellets. The pellets are then tumbled/spun with each other and heated to result in mostly spheroidal pellets whose mechanical characteristics allow them to be used with traditional agricultural equipment. The biochar can be produced with sulfur incorporated throughout the mixture as a binding agent or as an outer coating.

Methods of granulating peat are also known. For example, Lownds, U.S. Pat. No. 6,287,496 discloses methods of granulating peat using gentle extrusion conditions and viscosified water. According to the '496 patent, the peat-containing granules are produced from peat, a binder, optional additives, water, and an optional water soluble viscosifier. The preferred class of binders includes starches. Also, binders based on proteins, for example, casein, and soybean meal can be used. The '496 patent also discloses that polyvinyl alcohol, polyvinyl acetate, urea, and urea derivatives can also be used.

In addition, Von Blücher et al., U.S. Pat. No. 4,857,243 discloses a process of making micro spherules of activated carbon. The process involves kneading activated carbon particles of a size below 100 μm, together with a dispersion of a water-insoluble synthetic resin to form an intimate mixture; pressing the mixture through a screen having holes related to the size of the desired micro spherules; powdering the pressed material; and granulating and drying the resulting micro spherules.

However, there are some drawbacks with such conventional methods for pelletizing biochar. It would be desirable to have an improved binder that can be used to bind the biochar. The binder should be environmentally friendly and easy to use in a commercial method. The present invention provides an improved cellulose-based resin binder that can be used for binding biochar as well as other materials such as, for example, compost, activated carbon, industrial waste, seaweed, kelp, and the like. Other features, benefits, and advantages of the present invention are described further below.

### SUMMARY OF THE INVENTION

The present invention relates generally to a sustainable and tunable process for treating cellulose material to form biodegradable, moldable, and chemically modifiable resins, as well as products prepared therefrom. The cellulose-based resins can serve, for example, as adhesives, coatings, or binding agents for a wide variety of particulate, fibrous, and powder-like materials. The resultant materials may be used, for example, in the manufacture of biodegradable household, agricultural, industrial, environmental, and filtration products, including molded articles, soil amendments, biochar pellets, nutrient delivery systems, and remediation media.

In one embodiment, the present invention provides a process for preparing a cellulose-based resin, comprising the steps of: a) providing a starting cellulose material; b) heating the cellulose material so that the moisture content of the cellulose material is less than 20%; c) mixing the cellulose material in an aqueous alkali metal solution comprising potassium hydroxide, urea, and potassium carbonate to form a cellulose mixture; d) rinsing the cellulose material with water to remove excess alkali metal solution from the cellulose material; e) treating the cellulose material so that the moisture content of the cellulose material is at least 1% solids; and f) mechanically treating the cellulose material to reduce the size of the cellulose material and create a cellulose-based resin. In one embodiment, the process further comprises the step of incorporating a water-soluble or dispersible additive into the cellulose material prior to the step of mechanically treating the cellulose material.

The starting cellulose material is preferably in particle form comprising particles having a particle size of about 0.01 to about 2.0 inches. In one example, the starting cellulose material comprises particles having a size of about 0.02 to about 1.5 inches. Preferably, the cellulose material is heated so that that the material has a moisture content of less than about 10%. In one example, the cellulose material has a moisture content of about 8%. The resulting cellulose-based resin can comprise various additives. For example, additives for controlling nutrient release, pollutant adsorption, and microbial inoculation can be included in the resin. The cellulose-based resin is preferably biodegradable and compatible under field conditions as described further below.

Preferably, the ratio of potassium hydroxide to urea to potassium carbonate in the aqueous solution is 1:1:1. In one embodiment, the aqueous solution contains at least about 8.0% solids based on the total weight of the solution. In another embodiment, the aqueous solution contains at least about 10.0% solids based on the total weight of the solution. Preferably, the cellulose material is treated so that the composition has a 1% solids/wet ratio to about 20% solids/wet ratio. In one example, the cellulose material is treated so that the composition has a 4% solids/wet ratio.

The process of the present invention preferably produces a cellulose-based resin comprising cellulose-based particles. Preferably, the cellulose-based particles have a particle size in the range of about 1 micron to about 1800 microns. In one example, about 60 to about 90% of the cellulose-based particles have an average particle size in the range of about 1 to about 10 microns; and about 10 to about 40% of the cellulose-based particles have a particle size in the range of about 150 to about 500 microns.

Further, the present invention includes a process for producing pellets of biochar, compost, activated carbon, seaweed, kelp, manure, and mixtures thereof, comprising the steps of: a) providing a starting cellulose material; b) heating the cellulose material so that the moisture content of the cellulose material is less than 20%; c) mixing the cellulose material in an aqueous alkali metal solution comprising potassium hydroxide, urea, and potassium carbonate to form a cellulose mixture; d) rinsing the cellulose material with water to remove excess alkali metal solution from the cellulose material; e) treating the cellulose material so that the moisture content of the cellulose material is at least 1% solids; f) mechanically treating the cellulose material to reduce the size of the cellulose material and create a cellulose-based resin; g) mixing a material selected from the group consisting of biochar, compost, activated carbon, seaweed, kelp, manure, and mixtures thereof with the cellulose-based resin; and h) extruding the mixture to form pellets of a material selected from the group consisting of biochar, compost, activated carbon, and mixtures thereof. Preferably, the pelletized material is biochar. In other embodiments, an extruder is not used to form the pellets. Rather, manually-pressing the materials through a die and other processing steps can be used. The cellulose-based binder resin of the present invention exhibits exceptional versatility across a broad spectrum of materials, enabling the effective agglomeration, granulation, and densification of both organic and inorganic substrates.

In other embodiments, as described further below, the cellulose-based resin can be molded into a wide variety of articles such as, for example, cups, trays, packaging films, utensils, and containers. In yet other embodiment, the cellulose-based resin can be applied as a coating to molded pulp or paper products to improve oil, water, oxygen, and vapor barrier properties of the products.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a flowchart showing one embodiment of the process of the present invention for making a cellulose-based binder resin;

FIG. 2 is a photograph showing raw Cellulose Fibers and one embodiment of the cellulose-based binder resin made with the raw Cellulose Fibers in accordance with the present invention;

FIG. 3 is a set of photographs, wherein the first photograph shows a molded pulp bowl made of kraft pulp having an interior cavity that has not been coated with the cellulose-based binder resin of the present invention, and a second photograph showing a molded pulp bowl made of kraft pulp having an interior cavity that has been coated with one embodiment of the cellulose-based binder resin (PulpShield™) of the present invention;

FIG. 4 is a set of photographs, wherein the first photograph shows one embodiment of molded K-Cups made with the cellulose-based binder resin in accordance with the present invention, wherein the K-Cups include walls having a thickness of 0.030 inches, and the second photograph shows another embodiment of the molded K-Cups made with the cellulose-based binder resin in accordance with the present invention, wherein the K-Cups include walls supporting a chip having a thickness of 0.055 inches;

FIG. 5 is a photograph showing raw Biochar material, and pellets comprising the Biochar made with one embodiment of the cellulose-based binder resin in accordance with the present invention;

FIG. 6 is a photograph showing raw Kelp and Manure materials, and pellets comprising the Kelp and Manure made with one embodiment of the cellulose-based binder resin in accordance with the present invention;

FIG. 7 is a photograph showing raw Manure and Biochar materials, and pellets comprising the Manure and Biochar materials made with one embodiment of the cellulose-based binder resin in accordance with the present invention;

FIG. 8 is a photograph showing raw Activated Carbon material, and pellets comprising the Activated Carbon made with one embodiment of the cellulose-based binder resin in accordance with the present invention; and

FIG. 9 is a photograph showing raw Compost material, and pellets comprising the Compost made with one embodiment of the cellulose-based binder resin in accordance with the present invention.

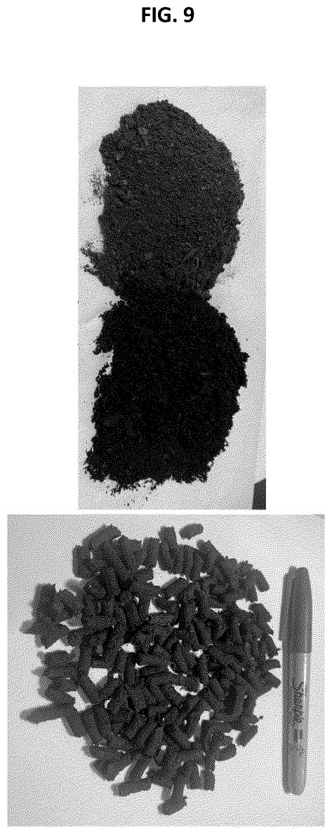

### DETAILED DESCRIPTION OF THE INVENTION

The present invention relates to a sustainable, adaptable process for preparing cellulose-based resins with biodegradable, moldable, and binding characteristics suitable for a wide range of industrial, agricultural, and environmental applications. The process comprises the treatment of cellulose material through thermal conditioning, optional chemical soaking in an alkali-based solution, and mechanical processing to produce a viscous, paste-like resin. This resin can be formulated using varied chemical agents—including potassium hydroxide, sodium hydroxide, urea, potassium carbonate, and sodium percarbonate—to tailor fiber swelling, delignification, porosity, and final product properties.

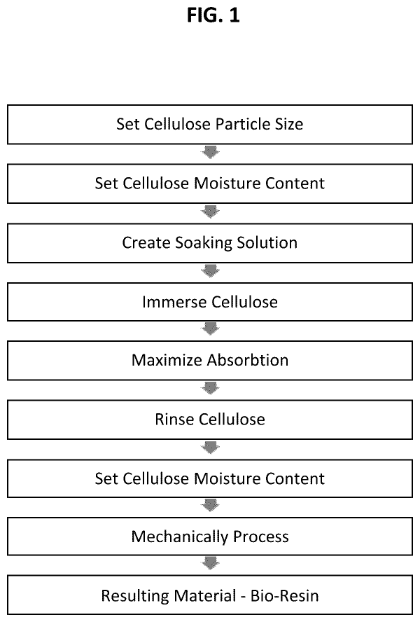

The process allows for controlled manipulation of fiber length and distribution to influence strength, flexibility, durometer, and degradation rate. The resulting cellulose-based resins may be used as adhesives, coatings, or binders for fine powders and particulate matter, including, for example, biochar, compost, activated carbon, industrial waste, seaweed, kelp, manure, and the like. In certain embodiments, the resin functions as a vehicle for nutrient or additive delivery and enables controlled field degradation aligned with composting or soil amendment objectives. Products formed from the resin may include molded articles, pellets, or granules optimized for strength, disintegration profile, or environmental compatibility, depending upon the intended end use. The process steps of one embodiment of the present invention are shown in the flowchart of FIG. 1 and discussed further below.

### Starting Cellulose Material

In general, cellulose is an organic compound having the formula (C₆H₁₀O₅), which can be represented by the structural formula:

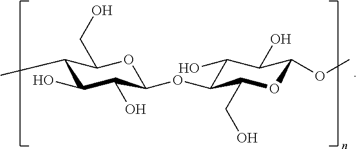

The glucose is a polysaccharide having a linear chain containing multiple glucose units that are bonded together. Many different forms of cellulose are known. The most common form of cellulose is found in plants, particularly plant fibers, fibrils, and microfibrils (hereinafter generally referred to as “fibers’), which includes wood pulp fiber and cotton fiber. Cellulose fiber also can be derived from microorganisms such as certain types of bacteria.

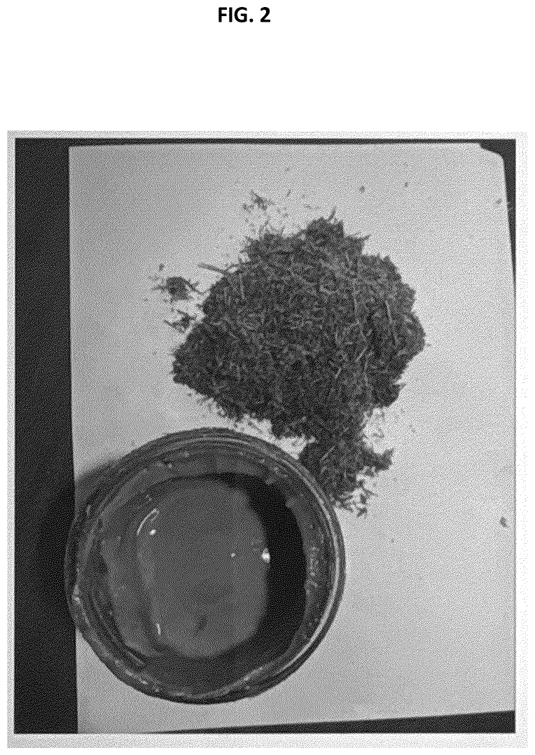

Any suitable cellulose fiber can be used in accordance with the present invention. The integrity, density, strengths, durometer, and other properties of the like, of subsequent parts/articles resulting from the processes of this invention can, in part, be controlled by the type of raw cellulose used. In FIG. 2, one example of suitable raw cellulose fibers is shown. The raw cellulose fibers can be used to make the cellulose-based binder resin as discussed further below. Cellulose fibers are found in many natural materials such as, for example, plants, cotton, wood pulp, food, and agricultural byproducts such as corn cobs and husks. The cellulose fiber can be derived from any suitable cellulose source. For example, the cellulose fiber can be derived from a marine source such as, for example, seaweed and kelp. The cellulose fiber can be a homogenous material, or different types of cellulose fiber can be blended together. Examples of wood pulp include wood pulp made from hardwood, softwood, and the like. Non-wood pulp made from flax, straw, kenaf, jute, sisal, bagasse, hemp, and the like can be used. Cellulose fiber generated from plants such as corn, beets, soy, wheat, whey, straw, hay and the like can be used. Other types of cellulose fiber that can be used in accordance with this invention include post-consumer waste such as waste-paper pulp. The cellulose can have different properties depending upon its chain length. If the cellulose is derived from wood pulp, it typically has chain lengths between 300 and 1700 units. If the cellulose is derived from cotton or other plants, it can have a chain length ranging from 800 to 10,000 units.

The cellulose fibers can be shaped and formed into a starting cellulose material suitable for use in the present invention by any suitable mechanical treating method. That is, the cellulose fibers are mechanically treated to reduce their size so they can be used in the process of this invention. For example, the cellulose can be shaped into a fibrous or powder (granule) form by using such methods as shredding, cutting, grinding, pulverizing, beating, and the like. Millstone machines such as grinder and mills, homogenizers, and refiners can be used to mechanically treat the cellulose fibers. The resulting cellulose material is a fibrous or powder (granule)-like material. Preferably, the resulting cellulose material, which is the starting cellulose material used in the process of the present invention, is in particle form having a particle size generally in the range of about 0.01 inches to about 2.00 inches. More preferably in the range of about 0.02 inches to about 1.50 inches. For example, in one embodiment the cellulose material has a particle size in the range of about 0.08 inches to 0.35 inches.

### Drying of Cellulose Material

The starting cellulose material, that preferably has been mechanically treated to reduce its size as described above, is then treated to remove moisture. In this step, the cellulose material is preferably heated to a temperature in the range of about 80° to about 195° F. More preferably, the temperature is in the range of about 95° to about 150° F. The cellulose material is heated for a sufficient period of time to reduce the moisture content of the material to the desired level. In one preferred embodiment, the cellulose material is heated for about 24 hours at a temperature of about 100° F. This heating step helps to dry out the cellulose material so that it is ready to be treated with an alkali hydroxide solution as described further below. In an alternative embodiment, drying is not required prior to chemical treatment; however, the initial moisture content must be measured and accounted for in a subsequent formulation step to ensure consistent concentration of the chemical soaking solution and uniformity in swelling and reactivity outcomes.

Preferably, the cellulose material is heated until it has a moisture content about 20% or less, more preferably about 10% or less. In one particularly preferred embodiment, the cellulose material is heated to dry the material such that it has a moisture content of about 8.3%. Any conventional heating device can be used to dry-out the cellulose material in accordance with the invention. For example, a Cosori Food Dehydration unit (available from Vesync Co., Ltd., Anaheim, CA. USA) can be used to dry-out the cellulose fiber.

### Soaking of Cellulose Material in Solution

Next, the dried cellulose material is soaked in an aqueous alkali metal hydroxide solution for a period of about six (6) to about twenty-six (26) hours, and more preferably about eight (8) to about twenty-four (24) hours at a temperature of about 60° to 195° F. This time period may vary based on the mixing and agitation of the material and temperature of the solution. Suitable alkali metal hydroxides that can be used in the solution include, for example, sodium hydroxide, lithium hydroxide, and potassium hydroxide. In one particularly preferred embodiment, potassium hydroxide is used.

The aqueous solution may comprise potassium hydroxide, which serves as a primary alkali agent for cellulose pretreatment. Potassium hydroxide facilitates fiber swelling, delignification, and disruption of inter-fiber bonding, thereby increasing the material's surface area and enhancing its susceptibility to mechanical fibrillation. The presence of potassium ions may impart beneficial agronomic properties to the final resin in soil-contact applications, such as biochar pellets or soil amendments, by contributing essential plant nutrients. Compared to other alkali agents, potassium hydroxide is especially effective in reducing fiber curl, minimizing agglomeration, and promoting uniform dispersion of cellulose fibers. It may be used alone or in conjunction with additives such as urea, potassium carbonate, and sodium percarbonate to fine-tune the soaking environment for targeted resin performance, including strength, degradation profile, and environmental compatibility.

The aqueous solution may also comprise sodium percarbonate. Sodium percarbonate functions as an oxidizing agent, decomposing into hydrogen peroxide and sodium carbonate in aqueous environments. The release of hydrogen peroxide promotes mild oxidation, which can aid in partial delignification, increase fiber porosity, and enhance fiber swelling. These effects contribute to improved mechanical processing and facilitate downstream binding performance. Suitable sodium percarbonate compositions include coated and uncoated grades, stabilized or combined with chelating agents to regulate oxidative activity. The use of sodium percarbonate may also contribute to sterilization or microbial suppression during the soaking phase, particularly beneficial in formulations intended for agricultural or environmental applications. Sodium percarbonate can be used alone or in combination with other alkali or carbonate additives to tailor the oxidative strength and buffering capacity of the solution.

The aqueous solution may further comprise sodium hydroxide as an alternative or supplemental alkali agent. Sodium hydroxide promotes fiber swelling, delignification, and de-bundling by disrupting hydrogen bonding within the cellulose structure, thereby facilitating enhanced accessibility for mechanical processing. The use of sodium hydroxide has been shown to increase fiber porosity, reduce curl and kink, and promote fibrillation, resulting in improved homogeneity and cohesion in the final resin matrix. While functionally similar to potassium hydroxide, sodium hydroxide may be preferred in formulations aimed at cost-sensitive applications or where sodium ion content is desired in the final product, such as certain soil or microbial environments. Sodium hydroxide can be used individually or in combination with urea, sodium percarbonate, or carbonate salts to tailor the soaking conditions and optimize resin performance across diverse use cases.

In the present invention, the ratio of sodium hydroxide to sodium percarbonate to potassium carbonate in the solution is preferably 1:1:1. The ratio of chemical components to water in the solution is preferably 5%-7%. The solution preferably contains at least 4% by weight of cellulose/organics based on total weight of the solution. In one preferred embodiment, the solution contains about 6% by weight solids. One objective of this step is to maximize the quantity of cellulose being soaked into the solution. The solution is continuously mixed and agitated as the cellulose material is added. Any suitable mixing unit can be used. In one example, a VivoHome electric hand-held mixer (110 volts, 1600 watts) (available from VivoHome Co., City of Industry, CA. USA) is used.

Swelling, the first metric considered, increases the surface area of the fibers, which makes them more pliable and allows for easier breakdown during mechanical processing. Higher degrees of swelling also indicate that the fiber is prepared for further processing; that is, the swelling reduces resistance to mechanical forces that may otherwise cause the fibers to break apart unevenly or not break apart at all. Fraying, on the other hand, enhances the material's ability to undergo further breakdown. It also indicates that the fiber is becoming more porous, which can improve bonding characteristics in subsequent steps. Simply stated, swelling and fraying were desirable results.

Cellulose fibers typically exhibit curl or kink, the second metric considered, due to processing and/or their natural structure; however, in this particular case, both are undesirable because they impede the fibers' ability to align property during processing, molding and/or mechanical processing. It has been found that treating the cellulose with this specific soaking formulation reduces and controls fiber curl and kink, which makes it easier to manage fiber orientation.

Another inherent property of cellulose fibers is to form bundles, or agglomerate, the third metric considered, owing to surface charge interactions and/or inter-fiber bonding. These bundles must be broken apart in order to achieve the desired fiber structure [and performance] in subsequent steps. It has been found that this specific pre-soak formulation reduces agglomeration, or helps to break up bundles into individual fibers, making it easier to handle the fibers during mechanical processing and ensures uniformity in later steps, such as, for example, composite forming.

The fourth metric considered was cell wall thickness, which directly affects rigidity and strength. In general, thicker walls mean that the fiber is harder to break down and will resist further processing. Thinner walls suggest easier fiber modification but could also indicate weaker fibers in the end products. Therefore, monitoring the cell wall thickness was critical because desirable and undesirable effects could arise.

The final metric considered was delignification. Lignin is a complex polymer that gives plants rigidity and structure but makes the material tough to decompose or convert into other forms. Delignification is the process of removing lignin from plant material to make it easier to break down or process. Therefore, this was another critical parameter throughout development.

In summation, mechanical higher degrees of swelling, fraying, and delignification indicated greater formula effectiveness, whereas curl, kink, and fiber bundling pointed to formula ineffectiveness, as the goal was to prepare the cellulose fibers for subsequent mechanical processing (further breakdown of the fibers), mixing, and/or application (i.e. molding, coating, etc.).

While not wishing to be bound by any theory, it has been found that treating the cellulose material with a specific formulation of potassium hydroxide, urea, and potassium carbonate as described above prepares the cellulose material to be mechanically processed into a viscous paste-like cellulose-based resin. Post mechanical processing, it is believed that pre-treating the cellulose material with this specific formulation causes the cellulose-based particles to better adhere to each other. The relatively high surface area of the cellulose-based particles further helps the particles to bond to each other. As a result, the particles tend to mechanically adhere to each other and form agglomerates and aggregates. The resulting cellulose-based resinous-like material has good physical properties.

The composition and concentration of the chemical soaking solution may be varied depending upon the desired properties of the end-use product. For example, applications requiring enhanced tensile strength, rigidity, or thermal resistance may benefit from higher concentrations of potassium hydroxide or extended soak times to promote greater delignification, swelling, cell wall breakdown, and metrics of the like. Conversely, for applications where rapid biodegradability or low-input processing is prioritized, such as in compostable pellet binders or field-deployable soil amendments, a reduced chemical load may be sufficient. In some embodiments, the pre-treatment step may be conducted using a water-only soak, without the addition of potassium hydroxide, urea, or carbonates. It has been found that in such cases, particularly where the end-product does not require high mechanical strength or barrier properties, the water soak alone may be adequate to pre-condition the cellulose material for mechanical processing. The resulting resin, while classified as a “low-grade” formulation, has demonstrated effective binding performance in agglomeration and pelletization applications where maximum physical properties are not critical. Furthermore, such low-grade formulations may offer additional benefits in accelerating degradation or disintegration rates post-application, which can be desirable in compostable packaging, field-spreadable pellets, or nutrient-release applications. This flexibility in pre-treatment enables cost optimization, reduces chemical use, and allows for application-specific customization of the resin's performance profile.

### Washing/Rinsing of Cellulose & Process Wastewater Recovery

The above-described soaked, wet, and pre-treated cellulose material can then be fed through a strainer to remove any excess solution from the material. After this straining step, the cellulose material can then be washed to remove any residual alkali metal solution. Preferably, but not mandated, deionized water is used to wash the cellulose material at room temperature. Any suitable at-home, lab-scale, or industrial washing/rinsing apparatus can be used to wash and rinse the cellulose material.

As part of the resin manufacturing process, in a previous step, the cellulose fibers are soaked in an aqueous alkali solution. This generates a wastewater stream containing residual organic compounds, particulates, and dissolved constituents from the soaking solution. To minimize environmental impact and improve process sustainability, analytical characterization of the effluent will include chemical oxygen demand (COD), total dissolved solids (TDS), total suspended solids (TSS), pH, and additive concentration profiling via techniques such as liquid chromatography (HPLC) or spectrophotometry. Filtration and separation technologies isolate and recover reusable additives creating a closed-loop system that enables the recovery and recirculation of active ingredients; reduces water consumption and environmental impact; enhances cost-effectiveness; and meets discharge standards for any residual effluent.

It is suggested that the filtered residuals and constituents of the effluent can be reused in a subsequent step.

### Treating of Cellulose Material to Set the Moisture Content

In this step, the washed and rinsed cellulose material is treated to increase the moisture content of the material to the desired level. In general, water is added to the washed and rinsed cellulose material so that the composition reaches the range of about 1% solids/wet to about 20% solids/wet. More preferably, the composition is in the range of about 2% solids/wet to about 10% solids/wet. In one particularly preferred embodiment, the composition is at 4% solids/wet. To achieve the target composition, the residual moisture content of the cellulose must first be measured, and the amount of added water adjusted accordingly, that is, the existing moisture is subtracted from the total required to reach the desired solids-to-liquid ratio. The specific moisture content will depend upon several factors including the mechanical processing machinery being utilized, molding techniques, and the product formulations being developed.

In this step, it has been found that utilizing alternative constituents in the pretreatment/soaking process can allow for useful residuals in the end product. For one example, using hydrogen-based chemicals and additives in the cellulose soaking process allows for useful residuals in the end product, resulting in a more efficient and cost-effective pretreatment process by eliminating the need to rinse the cellulose, recover effluent, and reset the moisture content of the cellulose/organic material.

This step may also be adapted to serve as a delivery vehicle for additional functional additives tailored to the intended end use. This phase allows for the homogeneous incorporation of water-soluble or dispersible agents including, but not limited to, nitrogen, phosphorus, and potassium fertilizers; micronutrients like calcium, magnesium, and sulfur; soil-enhancing compounds including humic acids, microbial inoculants, or bio-stimulants; and materials of the like. In environmental applications, the process may similarly accommodate the addition of activated carbon, zeolites, or metal chelators for pollutant adsorption. For instance, pellets intended for agricultural deployment could be fortified with slow-release NPK formulations, while those produced for compost activation might incorporate beneficial microbes or nitrogen-boosting compounds. Because the binder matrix is hydrophilic and polymerically stable during processing, it ensures even distribution of these agents throughout each pellet and facilitates their controlled release post-application resulting in a value-added product that functions not only as a stabilized carrier of biochar or compost but also as a customizable nutrient or remediation platform. In addition, by varying the chemical composition or concentration of additives incorporated during this stage, the resin can be tailored to meet the unique physical, chemical, or functional demands of different end-use scenarios-ranging from horticultural slow-release pellets to high-load remediation media or moisture-sensitive seed coatings.

### Mechanical Processing

In this step, the resultant cellulose material, which has undergone the treatment steps described above, is mechanically treated to reduce the size of the cellulose material and create a cellulose-based resin. Preferably, the final cellulose-based resin comprises cellulose-based particles having different particle sizes as described further below.

Throughout this stage of mechanical processing—although not necessary in circumstances of full processing through bacteria, chemical, ultra sonification, and processes of the like—multiple types of mechanical processing machinery can be utilized. Disc grinders and refiners; refiners; pulpers; extruders, and the like can be utilized. This equipment is used to produce a variety of fiber lengths and sizes which can ultimately be homogenized and mixed together to form a type of an adhesive, paste-like mixture. It has been found that varying fiber lengths can subsequently enhance strengths, insulating properties, durometer, moldability, and other properties and characteristics of the like. As noted above, different equipment including refiners, disc grinders, pulpers, extruders and the like can make modifying the particle size of the cellulose more economically feasible and efficient. It has been found that utilizing a range of very small fibers as a binding agent and/or filler type material, mixed with a range of larger fibers, (that is, a skeletal structure), helps to enhance the molding process and can highly modify the properties of the products prepared therefrom. Also, larger particles can help to distribute stresses in the process, preventing cracking, as well as help to mitigate some shrinkage.

A variety of particle sizes can be utilized to help enhance and vary properties of the end-use products. It has been found that, for example, flexibility, tensile strength, durometer, puncture resistance, tear resistance and properties of the like can be fully and/or partly altered with specific varying of the particle sizes.

The particle sizes and lengths can range anywhere from about 0.5 microns to about 2000.0 microns (2.00 mm); however, more preferably, the range is about 1 micron to about 1800 microns (1.8 mm). In one embodiment, about 65% of the cellulose-based particles have an average particle size in the range of about 1 to about 10 microns, while the remaining 35% of the cellulose-based particles have a particle size in the range of about 150 to about 500 microns. In this embodiment, to achieve this formulation utilizing a single mechanical processing machine, about 65% of the cellulose was “highly” processed while the remaining 35% of the cellulose was only “moderately” processed. The difference in processing creates a mixture of particle sizes. In this specific example, it is found that the resulting cellulose-based material molds into a strong and dense material.

In another embodiment, 100% of the cellulose-based particles have an average particle size in the range of about 1 to about 50 microns. In this embodiment, to achieve this formulation utilizing a single mechanical processing machine and additive/soaking vessel, 100% of the cellulose was “highly” processed. In this specific example, it is found that the resulting cellulose-based material can be coated on molded pulp and paper products, drastically increasing the product's properties, including, but not limited to, oil barrier; moisture transmission rate; water vapor transmission rate; oxygen transmission rate; grease penetration; vapor transmission; and properties of the like. In this specific example, it has been established that the material is effective as a binding agent. Furthermore, it has been found that in certain low-specification or short-lifespan applications—such as compostable field pellets or binder systems designed for rapid breakdown—the soaking process, discussed in a previous step, can be significantly altered, and changed to a water-only soak prior to mechanical processing. Although decreasing mechanical processability, the resulting “low-grade” resin, though exhibiting reduced mechanical strength and barrier properties, provides adequate cohesion for handling and application while also enhancing the degradation rate of the final product post-deployment. This characteristic is desirable in applications prioritizing compost ability, environmental disintegration, or nutrient release.

It has been found that including larger total percentages of highly processed shares of cellulose material—particle sizes in the about 1 to about 10 micron range (60 to 90% of total particles)—can drastically enhance properties such as moisture vapor transmission rate, oxygen transmission rate, and gas vapor transmission rate, all being highly important and imperative to certain industries such as dry food packaging.

### Resulting Cellulose Material

As discussed above, the cellulose material is treated to reduce the size of the cellulose material and create a cellulose-based, paste-like resin. In a subsequent step, the wet, cellulose-based, paste-like resin can be utilized as an organic binder, applied as an organic, compostable coating/sealant, and/or molded into articles and objects.

### Binding Agent

The cellulose-based binder of the present invention exhibits exceptional versatility across a broad spectrum of materials, enabling the effective agglomeration, granulation, and densification of both organic and inorganic substrates. Applicable to fine powders, fibrous residues, sludges, and ash-like particulates, the binder has demonstrated compatibility with materials including, but not limited to, biochar, compost, manure fibers, ammonium salts, activated carbon, charcoal, fly ash, diatomaceous earth, lime, silica, and gypsum. It has also shown efficacy in stabilizing and upcycling challenging agricultural and industrial waste materials such as spent mushroom substrate, extinguishing powder, asbestos, seafood processing byproducts, metal powders, sludge ash, and crop residues.

The cellulose-based resin also binds more complex or irregular waste streams such as spent mushroom substrate, seafood processing byproducts, extinguishing powder, metal dusts, crop residues, and wastewater treatment sludge. This broad binding capability supports diverse use cases across agriculture, waste management, environmental remediation, filtration, and material science—making the binder a flexible platform for converting unstable, powdery, or difficult-to-handle materials into stable, transportable, and application-ready forms.

When used as a binder, the cellulose-based resin exhibits excellent adhesion and agglomeration properties, enabling the durable binding of both untreated and pretreated organic materials. It has been found that in pelletizing applications—particularly those involving lightweight, friable, or ash-rich substrates such as biochar, compost, or agricultural waste—a high proportion of highly processed cellulose shares (i.e., particles in the range of approximately 1 to 10 microns) are desirable. These fine particles contribute to increased surface area, improved cohesion between binder and substrate, enhanced pellet uniformity, and superior moisture absorbency. These factors are critical for achieving optimal mechanical strength during transport and storage, while also promoting efficient disintegration and nutrient dispersion upon field application. Additionally, it has been determined that low-grade resin formulations are effective in this application. In this context, “low-grade” refers to binder input materials that require minimal or no chemical pretreatment, wherein the soaking or pre-conditioning phase may be performed using only water. This reduction or elimination of chemical inputs significantly lowers production costs and environmental impact, without compromising binder efficacy in forming structurally stable, compostable pellets across a wide range of feedstocks and use environments.

As discussed above, the cellulose-based binder of the present invention can be used across a wide range of industries. These include, without limitation, the production of pellets for soil amendment, animal bedding, biofuels, and slow-release fertilizers; the formulation of briquettes for energy applications; and environmental remediation media for stormwater filtration, VOC absorption, PFAS mitigation, and heavy metal sequestration. Additional applications include wood adhesives, controlled nutrient delivery systems, and pest control formulations. The binder has further demonstrated utility as a crosslinking agent, moisture retention enhancer, and carrier mechanism for bioactive ingredients.

One particularly preferred application of the cellulose-based resin binder of the present invention is to biochar, a carbon-rich, porous material derived from pyrolyzed biomass. Biochar exhibits high surface area, hygroscopicity, and chemical stability but presents substantial logistical and application challenges in unbound form, particularly due to its powdery texture, low bulk density, and susceptibility to wind and water displacement. Up to 55% of field-applied unpelletized biochar may be lost due to environmental dispersion during or after application.

These challenges are compounded by difficulties in transportation, handling, and storage. Raw biochar's low density and bulk volume make it expensive to package and inefficient to ship. Additionally, airborne particulates from ash-like biochar pose inhalation hazards during handling. Conventional mitigation strategies—such as localized sourcing, optimized packaging, and temporary moisture control—have failed to provide a scalable, durable solution.

It is well-established in the scientific and agricultural communities that pelletizing biochar improves its density, reduces airborne loss, and enhances supply chain logistics. However, effective pelletization requires a binder that is 1) certified organic, 2) capable of withstanding the mechanical forces of packaging and application, and 3) degradable at a rate compatible with compost and/or fertilizer breakdown cycles.

The cellulose-based binder resin of the present invention fulfills all three requirements. It enables the formation of cohesive, high-integrity pellets that retain structural stability during storage and distribution, yet disintegrate rapidly post-application, releasing nutrients and improving soil characteristics. The resin is compatible with biochar in both untreated and pretreated forms. In the present embodiment, the binder may be applied to biochar that has been pre-soaked in water or in a dilute chemical solution to enhance particle cohesion. The functional performance of the binder is not dependent on the grade or purity of the resin used, and low-specification resins have proven sufficient for pelletization, enabling the use of cost-effective, lower-grade input materials without compromising efficacy.

The present invention is further illustrated by the following Examples, but these Examples should not be construed as limiting the scope of the invention.

### Examples

### Binding Agent

Binder ratios were optimized through a series of experimental iterations to balance granule durability with post-application breakdown rates. The ideal ratio of biochar to binder was identified to support structural cohesion during transportation, handling, and application while facilitating rapid degradation in soil. The ratio can range from 3%-20% binder by dry weight. More preferably, the range is between 4%-10%. In one preferred embodiment, 7.1% binder by dry weight was utilized. The mixture that will be extruded has an ideal mass ratio of binder to biochar in the range of 0.3:10 to 2.0 to 10. In one preferred embodiment, the ratio of binder to biochar is 0.71 to 10.

Further, it was determined that increasing the surface area of the input materials-via finer particle sizes and additional processing-enhances the resin's moisture absorption properties, as measured using TAPPI T432 Water Absorbency standards. Increased water uptake accelerates pellet disintegration and promotes more efficient nutrient dispersion once applied to soil.

Material density was also a critical consideration. Denser granules improve mechanical handling and reduce shipping volume but tend to degrade more slowly. Through controlled manipulation of particle sizes, moisture content, biochar-to-compost ratios, and binder content—along with pressure-based compaction during pelletization—the resulting material achieves a density profile that balances both supply chain efficiency and compost ability. These performance metrics were validated through ASTM D792 (density) and compost windrow testing in partnership with the Center for Sustainable Organic Agriculture.

Biochar produced from diverse biomass sources exhibits significant variation in structure and composition. Wood-derived biochar possess high fixed carbon content, low ash levels, and dense carbon matrices. These materials are well-suited for long-term carbon sequestration but are nutritionally inert. In contrast, non-wood biochar, derived from straws, husks, or grasses, exhibit higher ash and nutrient content, greater alkalinity, and elevated cation exchange capacity (CEC), but are structurally weaker and more friable.

Unbound, both classes of biochar suffer from poor cohesion, low bulk density, and excessive dust generation. These characteristics render raw biochar incompatible with conventional agricultural spreaders, while also increasing labor and transportation costs. The cellulose-based binder resin overcomes these limitations by facilitating the conversion of loose biochar into high-integrity pellets without compromising key material properties such as porosity, hydrophilicity, nutrient content, or biodegradability.

The cellulose-based binder resin enables consistent pelletization of biochar from both wood and non-wood sources, including heterogeneous or impure biomass blends. It also supports pellet production for a wide array of use cases, including: Agriculture and Soil Amendment, Water and Air Filtration, Livestock Systems, Environmental Remediation, Construction and Insulation Materials, Waste Management and Composting, and Carbon Sequestration.

As discussed above, the cellulose-based binder resin of the present invention exhibits exceptional versatility across a broad spectrum of materials, enabling the effective agglomeration, granulation, and densification of both organic and inorganic substrates. Applicable to fine powders, fibrous residues, sludges, and ash-like particulates, the binder has demonstrated compatibility with materials including, but not limited to, biochar, compost, manure fibers, ammonium salts, activated carbon, charcoal, fly ash, diatomaceous earth, lime, silica, and gypsum.

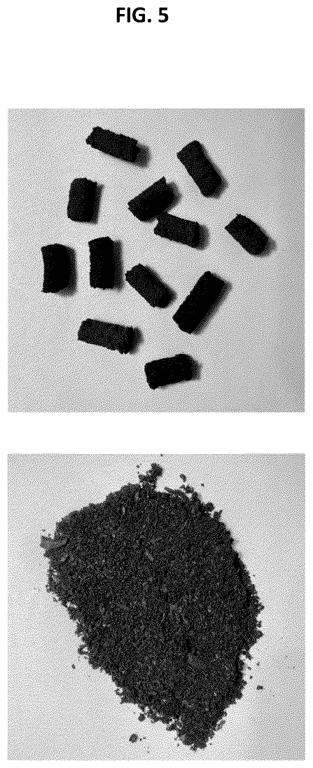

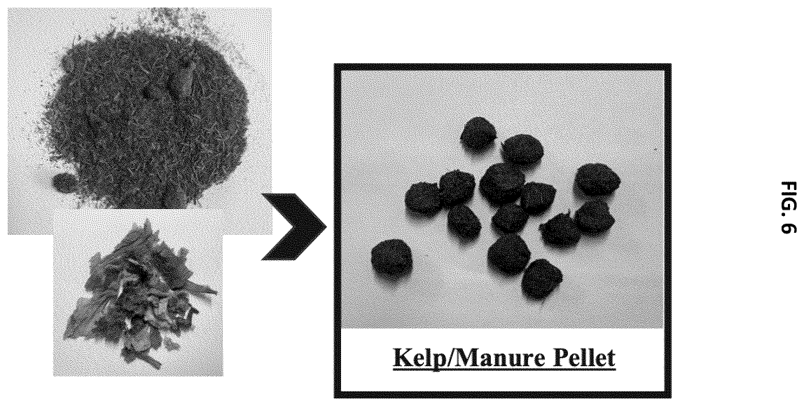

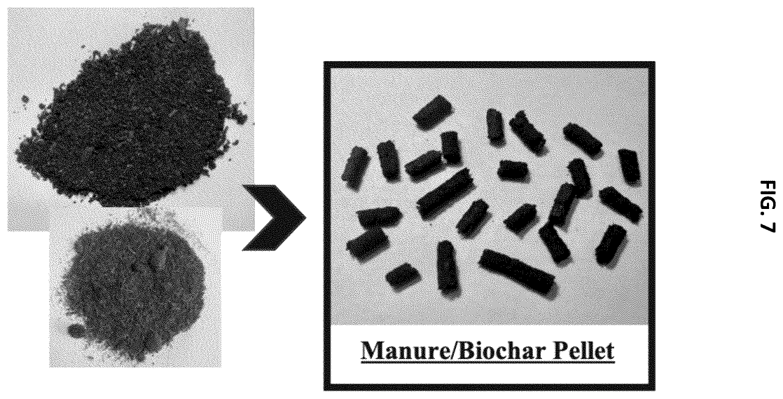

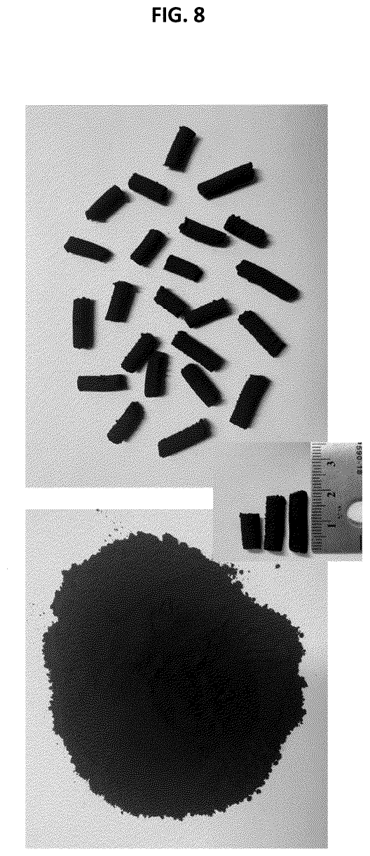

Referring to FIG. 5, raw Biochar material, and pellets comprising the Biochar made the cellulose-based binder resin are shown. In FIG. 6, raw Kelp and Manure materials, and pellets comprising the Kelp and Manure made with the cellulose-based binder resin are shown. FIG. 7 shows raw Manure and Biochar materials, and pellets comprising the Manure and Biochar materials made with the cellulose-based binder resin. FIGS. 8 (raw Activated Carbon) and 9 (raw Compost) materials show pellets comprising these respective raw materials and cellulose-based binder resin, wherein the size of the pellets is also generally shown.

TABLE 1
Typical Properties of Wood vs. Non-Wood Biochars

| Property | Wood Biochar | Non-Wood Biochar |
|---|---|---|
| Fixed Carbon (% wt) | 60-90% | 40-70% |
| Ash Content (% wt) | 1-10% | 10-40% |
| BET Surface Area (m²/g) | 50-450 | 20-400 |
| Bulk Density (kg/m³) | 180-240 | 140-200 |
| pH (1:5 extract) | 6.0-9.0 | 8.0-11.0 |
| CEC (cmol(+)/kg) | 1-6 | 10-35 |
| EC (dS/m) | 0.5-2.0 | 1.5-4.0 |
| Moisture Holding (g/g) | 15-25 | 10-25 |
| H/C Ratio (Stability Index) | <0.4 | 0.3-0.6 |
| Nutrient Content | Low | Moderate-High |

The cellulose-based organic binder enables the reliable densification and stabilization of biochar materials with variable chemical and physical properties. Its formulation supports the use of low-grade resin inputs and accommodates biochar pre-treatment with water or mild chemical solutions. The resulting pellets are durable, easy to handle, compatible with conventional application methods, and suitable for deployment across agriculture, filtration, environmental remediation, and material science sectors. This binder represents a critical enabling technology for the scalable commercialization and functional deployment of biochar across diverse markets in commercial and environmental contexts.

### Barrier Coating

With process variations, the viscosity properties can be altered, and it has been found that the cellulose-based resin of the present invention can be modified to have gel-like properties and be coated onto molded pulp and paper products to exponentially increase their oil, water vapor, oxygen, and other barrier properties-properties comparable to those of conventional food packaging materials, e.g. low-density polyethylene, oriented polypropylene, and polyethylene terephthalate. This performance is attributed to the resin's hydrophilic yet cross-linkable matrix, which forms a semi-permeable film capable of resisting moisture and gas transmission while maintaining flexibility. With viscosity flexibility, the material can now be coated via a variety of standard industrial equipment. For example, common coating techniques such as spray coating, brush coating, dip coating, roll-to-roll coating, and the like can be used.

Upon successful coating of the resin, we determined and tested numerous metrics to ensure industry standards. Specifically in dry food packaging, food longevity and shelf-life are of utmost importance, as they directly impact the quality, safety, and consumer satisfaction of the product. Effective packaging plays a crucial role in preserving freshness, preventing contamination, and maintaining the food's nutritional value over time; therefore, the focus was oxygen, water vapor, and grease transmission rates, and coating/material thickness.

That said, determining Thickness (TAPPI T411), which typically measures single sheet thickness of films, textiles, composites, and paperboards, was critical because it is one of the most important characteristics that not only affects barrier properties, e.g. transmission rates, but flexural strengths as well. This method measured our resin in a single-sheet thickness.

Moreover, Oxygen Transmission Rate (ASTM D3985) was used to determine the oxygen permeation rate of our resin. Key factors to understand included thickness and density of the material and environmental factors, such as relative humidity and temperature. At selected temperatures and humidities, our barrier film was sealed between a chamber containing oxygen and a chamber void of oxygen. A coulometric sensor then measured the oxygen that is transmitted through the material.

Furthermore, Water Vapor Transmission Rate (ASTM F 1249) was utilized to measure the water vapor transmission rate through our flexible barrier material. Again, key factors to understand material permeation included thickness of the material and environmental factors, such as relative humidity and temperature. This method was determined and utilized because it is the primary method applicable to sheets and films up to 3 mm (0.1 in.) in thickness, consisting of single or multilayer synthetic or natural polymers and foils, which include coated materials. At varying selected temperatures and humidity, our film was sealed between a wet and dry chamber. A pressure modulated sensor then measured the moisture transmitted.

Oil barrier properties are also critically important to all types of food packaging. To ensure industry standard results, we utilized (TAPPI T559), termed the KIT Test, which measured the degree of repellence or anti-wicking of the molded resin. Test solutions with varying strengths of castor oil, toluene, heptane and turpentine are used. The highest numbered solution (the most aggressive) that remains on the surface of the paper without causing failure is reported as the ‘KIT Rating’ (maximum 12).

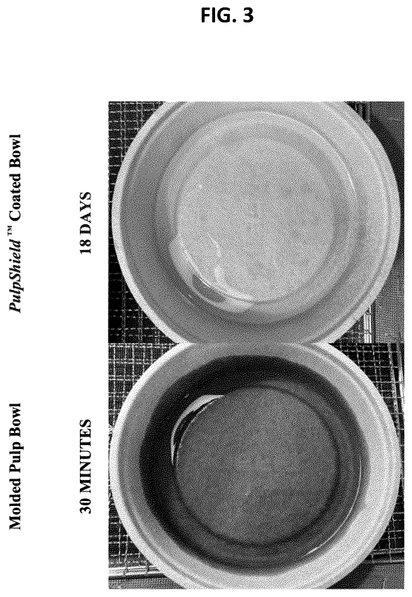

Referring to FIG. 3, a traditional molded pulp bowl was made out of kraft pulp and produced via a pulp thermoforming machine. The comparison depicts how oil poured into the traditional molded pulp bowl (the left-side photograph) immediately starts to penetrate and saturate into the material (exhibited by the dark staining of the bowl's interior), whereas a traditional molded pulp bowl made from the same material, and produced in the same way, when coated with the cellulose-based binder resin of the present invention (PulpShield™) (the right-side photograph) prior to oil being poured into the bowl, exhibited superior oil and oxygen barrier properties as shown by the clear view of the oil in the bowl, showing no visible signs of penetration/saturation after 18 days. This PulpShield™ coated bowl successfully blocked the oil penetration for months.

The below Table 2 further illustrates some of the properties of the cellulose-based binder resin of the present invention as discussed above versus conventional coatings.

TABLE 2
Properties of Coatings

| | Water Vapor | Oxygen | | |
|---|---|---|---|---|
| | Transmission□ | Transmission□ | Grease | Biodegradability/ |
| Coating | [g/(m²-day)] | [cc/(m²-day)] | Resistance□□ | Compost ability |
| Material | ASTM F1249 | ASTM D3985 | KIT Test | ASTM 6400 |
| Cellulose-Based | 30.6 | 1.88 | 12 | 45 Days |
| Resin With | | | | |
| Gel-Like | | | | |
| Properties | | | | |
| Low Density | 16-23 | 7,000 to 8,500 | 12 | Never |
| Polyethylene | | | | |
| (LDPE)* | | | | |
| Ethylene Vinyl | 14.3 to 217 | 0.310 to 1.55 | 12 | Never |
| Alcohol | | | | |
| (EVOH)** | | | | |
| Molded Pulp | 690 | 12,000+ | 5 | 180 Days |

□Water Vapor Transmission Rate and Oxygen Transmission—Measures the water vapor/oxygen passing through a material. Low transmission equals a stronger barrier, that is a lower number means a better barrier.
□□Grease Resistance—Measured on a Scale of 1 to 12, wherein a rating of 12 means the most optimal grease resistance.
*Low Density Polyethylene—A common plastic used in a wide variety of conventional packaging applications.
**Ethylene Vinyl Alcohol—A plastic resin used as an oxygen barrier in conventional food packaging.

As shown in Table 2 above, the cellulose-based resin of the present invention has superior oil and grease barrier properties; no PFAs, harmful chemicals, or adhesives. Additionally, the cellulose-based resin is 100% bio-based carbon and non-toxic and is at-home and industrial compostable. Also, the cellulose-based resin has good food contact compliance and oxygen barrier properties comparable to ethylene vinyl alcohol (EVOH). Furthermore, the cellulose-based resin can be applied using conventional coating methods.

### The Moldable Resin

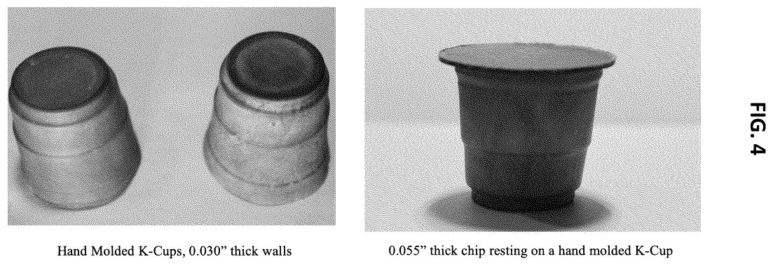

Owing to the viscosity flexibility of the process of the present invention, the cellulose-based resin can be altered into a paste-like material that can be thermally or mechanically shaped into household and industrial articles. In FIG. 4, one example of suitable molded K-Cups made with the cellulose-based resin in accordance with the present invention is shown. The molded articles have been shown to possess an exponential increase in oil, water vapor, oxygen, and other barrier properties compared to current molded pulp technology. In addition to barrier enhancements, molded applications take advantage of the resin's customizable mechanical properties, showing significant increases in tensile strength, durometer, puncture resistance, sheen, flexibility, and properties of the like, achieved through viscosity, particle size, and moisture control during processing.

When molded, the material shows significant increase in tensile strength and sheen. For example, common molding techniques such as compression-molding, injection-molding, spray-molding, casting, blow-molding, extrusion-molding, and the like can be used. The cellulose-based resin composition can be used to form a wide variety of end-use products such as, for example, medicine/pill cups; dry food packaging; cups, plates, and bowls; and disposable cutlery using any suitable manufacturing technique. Because the resin can be optimized for either rigidity or elasticity, it supports both rigid structural items and flexible packaging formats. The resin also maintains biodegradability and compost ability post-molding, making it well-suited for single-use applications that must meet environmental compliance.

Beyond bulk applications, the process creates a resin that is adaptable for molded products such as 3D printing resins, medical trays, ear specula, and egg cartons.

### Additives & Fillers

The cellulose-based resin composition can contain a wide variety of fillers and additives to impart specific properties to the molded or coated article. Suitable examples of additives and fillers include, but are not limited to, optical brighteners, coloring agents, fluorescent agents, viscosity varying agents, flame retardants, whitening agents, UV absorbers, waxes, light stabilizers, surfactants, metal powders, particularly conductive powders, processing aids, antioxidants, stabilizers, liquifying agents, softening agents, latex, fragrance components, plasticizers, impact modifiers, titanium dioxide, clay, mica, talc, glass flakes, milled glass, and mixtures thereof. Various pigments and colorants can be added. Additives may be selected based on targeted applications, for example, UV absorbers and light stabilizers for outdoor exposure durability; antimicrobial agents for medical or food-contact items; and plasticizers for improved flexibility and elongation in molded packaging. The resin's hydrophilic matrix allows uniform dispersion of such additives, ensuring consistency in performance across each product unit. Furthermore, the resin can serve as a vehicle delivery system for functional agents such as fertilizers (e.g., nitrogen, phosphorus, potassium), soil amendments (e.g., humic acids, microbial inoculants), or environmental remediation additives (e.g., activated carbon, chelators, and zeolites). These components can be homogenized into the resin during processing and released controllably post-application, making the material a customizable platform for targeted nutrient delivery and contaminant sequestration.

The present invention provides a more cost-effective, time-efficient, and environmentally friendly process for treating cellulose fiber than many conventional systems. The process also has additional features and advantages. For example, the cellulose-based, paste-like resin can be utilized throughout a variety of industries, and products produced by the process of this invention are biodegradable and can be disposed of in a variety of ways without harmful environmental effects. Notably, the invention integrates upstream and downstream sustainability features, including low-toxicity chemical options, effluent recovery and reuse, and compatibility with composting systems. The flexibility in pre-treatment, mechanical processing, and additive incorporation enables end-use customization, ranging from agricultural pellet binders to high-barrier coatings and molded consumer goods.

It should be understood that the compositions, formulations, materials, methods, processes, and the like described and illustrated herein represent only some embodiments of the invention. It is appreciated by those skilled in the art that various changes and additions can be made to the compositions, formulations, materials, methods, processes, and the like without departing from the spirit and scope of this invention. It is intended that all such embodiments be covered by the appended claims.

We claim:

1. A process for preparing a cellulose-based resin, comprising the steps of:
providing a starting cellulose material;
heating the cellulose material so that the moisture content of the cellulose material is less than 20%;
mixing the cellulose material in an aqueous alkali metal solution comprising potassium hydroxide, urea, potassium carbonate, to form a cellulose mixture;
rinsing the cellulose material with water to remove excess alkali metal solution from the cellulose material;
treating the cellulose material so that the moisture content of the cellulose material is at least 1% solids; and
mechanically treating the cellulose material to reduce the size of the cellulose material and create a cellulose-based resin.

2. The process of claim 1, wherein the starting cellulose material is in particle form having a size of about 0.01 to about 2.0 inches.

3. The process of claim 2, wherein the starting cellulose material is in particle form having a size of about 0.02 to about 1.5 inches.

4. The process of claim 1, wherein the cellulose is heated so that that the cellulose material has a moisture content of less than about 10%.

5. The process of claim 4, wherein the cellulose material is heated so that the cellulose material has a moisture content of about 8%.

6. The process of claim 1, wherein the ratio of potassium hydroxide to urea to potassium carbonate in the aqueous solution is 1:1:1.

7. The process of claim 6, wherein the aqueous solution contains at least about 8.0% solids based on the total weight of the solution.

8. The process of claim 7, wherein the aqueous solution contains at least about 10.0% solids based on the total weight of the solution.

9. The process of claim 1, wherein the cellulose material is treated so that the composition has a 1% solids/wet ratio to about 20% solids/wet ratio.

10. The process of claim 9, wherein the cellulose material is treated so that the composition has a 4% solids/wet ratio.

11. The process of claim 1, wherein the cellulose-based resin comprises cellulose-based particles.

12. The process of claim 11, wherein the cellulose-based particles have a particle size in the range of about 1 micron to about 1800 microns.

13. The process of claim 11, wherein about 60 to about 90% of the cellulose-based particles have an average particle size in the range of about 1 to about 10 microns; and about 10 to about 40% of the cellulose-based particles have a particle size in the range of about 150 to about 500 microns.

14. The process of claim 1, further comprising the step of incorporating a water-soluble or dispersible additive into the cellulose material prior to the step of mechanically treating the cellulose material.

15. A process for producing pellets of biochar, compost, activated carbon, and mixtures thereof, comprising the steps of:
providing a starting cellulose material;
heating the cellulose material so that the moisture content of the cellulose material is less than 20%;
mixing the cellulose material in an aqueous alkali metal solution comprising potassium hydroxide, urea, and potassium carbonate to form a cellulose mixture;
rinsing the cellulose material with water to remove excess alkali metal solution from the cellulose material;
treating the cellulose material so that the moisture content of the cellulose material is at least 1% solids;
mechanically treating the cellulose material to reduce the size of the cellulose material and create a cellulose-based resin;
mixing a material selected from the group consisting of biochar, compost, activated carbon, seaweed, and kelp, and mixtures thereof with the cellulose-based resin;
extruding the mixture to form pellets of a material selected from the group consisting of biochar, compost, activated carbon, and mixtures thereof.

16. The process of claim 15, wherein the material is biochar.

17. A cellulose-based resin produced according to the process of claim 1.

18. The process of claim 17, wherein the cellulose-based resin comprises cellulose-based particles.

19. The process of claim 18, wherein the cellulose-based particles have a particle size in the range of about 1 micron to about 1800 microns.

20. The process of claim 18, wherein about 60 to about 90% of the cellulose-based particles have an average particle size in the range of about 1 to about 10 microns; and about 10 to about 40% of the cellulose-based particles have a particle size in the range of about 150 to about 500 microns.
